(19) United States
(12) Patent Application Publication
(10) Pub. No.: US 2025/0104683 A1
(43) Pub. Date: Mar. 27, 2025

(54) MOTOR VEHICLE WITH IMPROVED ACTIVE ROAD NOISE CANCELLING APPARATUS

(71) Applicant: FERRARI S.P.A., Modena (MO) (IT)

(72) Inventors: Stefano IZZO, Modena (MO) (IT); Marco BALLATORE, Modena (MO) (IT); Francesco FABBRI, Modena (MO) (IT); Axel JALIBERT, Modena (MO) (IT)

(73) Assignee: FERRARI S.P.A., Modena (MO) (IT)

(21) Appl. No.: 18/822,741

(22) Filed: Sep. 3, 2024

(30) Foreign Application Priority Data
Sep. 25, 2023 (IT) 102023000019644

(51) Int. Cl. G10K 11/178

(52) U.S. Cl. CPC G10K 11/17815; G10K 2210/12821

(57) ABSTRACT

A motor vehicle includes a body comprising a chassis, walls delimiting a passenger compartment, at least one actuator applied to a corresponding wall between said walls and controllable through a control input signal to transmit a vibration corresponding to the control input signal to the corresponding wall, thereby producing a corresponding sound inside the passenger compartment, an error sensor configured to detect a quantity indicative of a residual sound produced by a superposition of said sound with an interior noise inside the passenger compartment and to generate a related error signal, and a control unit coupled to the error sensor to receive the error signal, configured to execute an active noise cancellation algorithm based on the error signal, so as to determine the control input signal adapted to minimize or reduce the residual sound, and further configured to control the actuator with the determined control input signal.

### CROSS-REFERENCE TO RELATED APPLICATION

This patent application claims priority from Italian patent application no. 102023000019644 filed on Sep. 25, 2023, the entire disclosure of which is incorporated herein by reference.

### TECHNICAL FIELD

The invention relates to a motor vehicle provided with an active noise cancelling apparatus and more specifically road noise, i.e. the noise perceptible in the passenger compartment substantially or to a greater extent caused by the rolling of the tyres on the road.

### BACKGROUND

As is known, some motor vehicles and especially the high-end ones, are provided with an active road noise cancelling apparatus. Usually, the apparatus is provided in turn with specific transducers, a control unit configured to receive the signals generated by the transducers, and sound emitting devices controlled by the control unit based on the received signals according to a control scheme for emitting sounds inside the passenger compartment of the motor vehicle. The emitted sounds are adapted to superpose the road noise perceptible in the passenger compartment with an effect of reducing or cancelling the road noise.

The transducers can include for example sound pressure sensors, such as microphones, configured to detect a residual of the road noise in the passenger compartment, also called error, and possibly in addition vibration sensors configured to detect quantities indicative of vibrations at the supposed sources of the road noise, i.e. zones in the proximity of the wheels or more in general of the four corners of the motor vehicle (substantially considered as a rectangle in plan view). Therefore, the vibration sensors, such as accelerometers and strain gauges, or more precisely their sensible members are generally placed near the wheels or the four corners, for example at the upper supports of the suspensions of the wheels or on the wheel hubs.

The sound emitting devices are normally electroacoustic transducers or loudspeakers integrated in the upholstery of the passenger compartment and configured to emit the sounds directly in the passenger compartment.

The control scheme most commonly adopted by the control unit is a scheme of predictive type or more precisely called feedforward. In particular, the signals related to the quantities detected by the vibration sensors form a reference signal, which is provided together with a signal representative of the error as inputs of an adaptive filter of the class of the least mean squares algorithms, from which a control input is obtained at the output for the sound emitting devices, by means of which the sound emitting devices progressively reduce the error. The reference signal is generally considered very important as it represents an additional piece of information with respect to the sole piece of information about the error, by means of which it is possible to adopt only a feedback control scheme. For this reason, there is a tendency in the field to increase the number of the vibration sensors with the aim to increase the wealth of information of the reference signal. On the other hand, the increase in the number of sensors constitutes a drawback from the point of view of the efficiency and of the resulting complexity of the apparatus. Therefore, the need is felt to improve the efficacy of the apparatus without necessarily falling within the drawback just mentioned.

An object of the invention is to satisfy the need set forth above, preferably in a simple and repeatable manner.

### DESCRIPTION OF THE INVENTION

In one aspect, the invention can be a motor vehicle comprising a body comprising a chassis and a plurality of walls, the walls delimiting a passenger compartment to accommodate one or more passengers, at least one actuator applied to a corresponding wall between said walls and controllable through a control input signal to transmit a vibration corresponding to the control input signal to the corresponding wall, thereby producing a corresponding sound inside the passenger compartment, an error sensor configured to detect a quantity indicative of a residual sound produced by a superposition of said sound with an interior noise inside the passenger compartment and to generate a related error signal, and a control unit coupled to the error sensor to receive the error signal, configured to execute an active noise cancellation algorithm based on the error signal, so as to determine the control input signal adapted to minimize or reduce the residual sound, and further configured to control the actuator with the determined control input signal.

In one aspect, the invention can be a motor vehicle comprising a body including a chassis, a passenger compartment to accommodate one or more passengers, and a wall. The motor vehicle further comprises an actuator applied to the wall, wherein the actuator is controllable through a control input signal to transmit a vibration corresponding to the control input signal to the wall thereby producing a corresponding sound inside the passenger compartment, an error sensor configured to detect a quantity indicative of a residual sound produced by a superposition of said sound with an interior noise inside the passenger compartment and to generate a related error signal, and a control unit configured to receive the error signal, execute an active noise cancellation algorithm based on the error signal, so as to determine the control input signal adapted to reduce the residual sound, and control the actuator with the determined control input signal.

### BRIEF DESCRIPTION OF THE DRAWINGS

In the following, an embodiment of the invention is described for a better understanding thereof by way of non-limiting example and with reference to the accompanying drawings wherein:

FIG. 1 is a perspective view of a motor vehicle according to the invention;

FIG. 2 is a plan view of the motor vehicle in FIG. 1;

FIGS. 3 and 4 are perspective views, on an enlarged scale and with parts removed for clarity, of a door of the motor vehicle, with the addition of an enlargement of a detailed portion of a window coupled to the door, according to respective variations of the motor vehicle;

FIG. 5 is a block diagram of a noise cancellation algorithm executed by a control unit of the motor vehicle;

FIG. 6 is an alternative variation of the noise cancellation algorithm in FIG. 5; and

FIG. 7 is a side view of the motor vehicle, with parts removed so as to show a passenger compartment inside the motor vehicle.

### DETAILED DESCRIPTION OF THE INVENTION

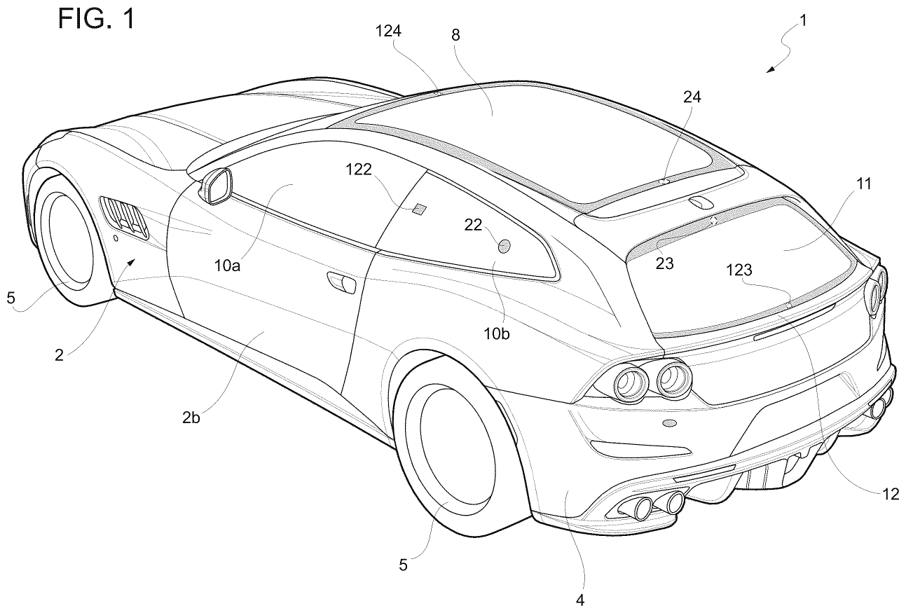

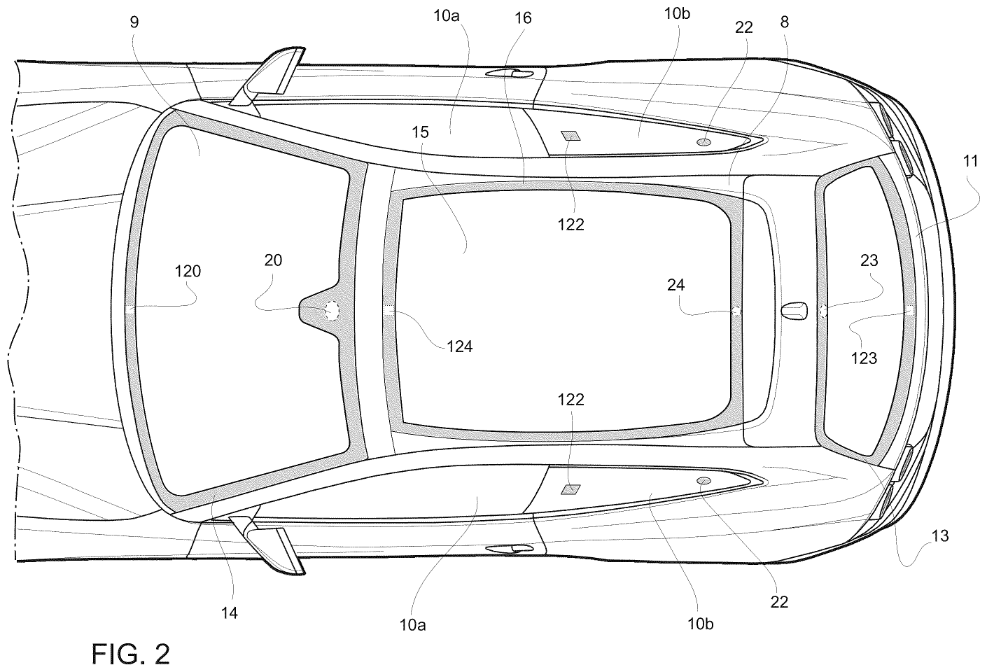

In FIG. 1, reference numeral 1 is used to indicate, as a whole, a motor vehicle.

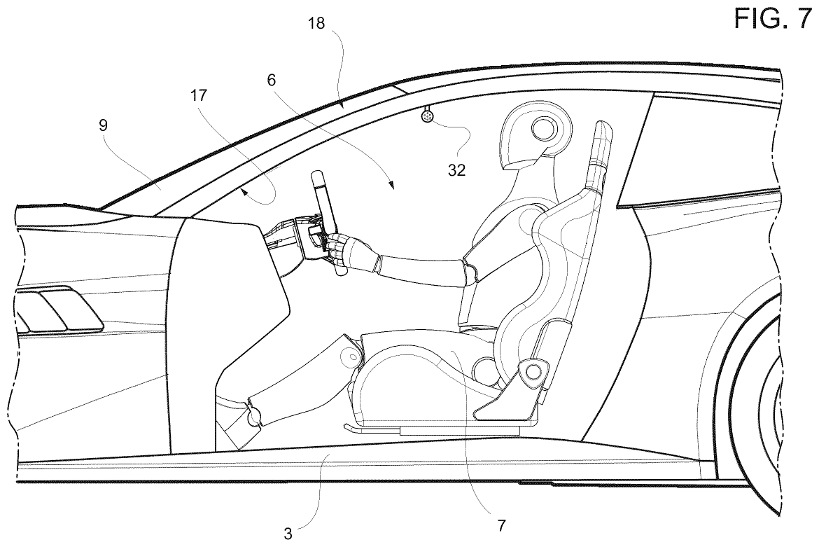

The motor vehicle 1 comprises a body 2, in turn including a chassis 3 (FIG. 7) and a bodywork 4 carried by the chassis 3 and defining the outer surfaces of the motor vehicle 1.

Furthermore, the motor vehicle 1 comprises a plurality of wheels 5, (only two of which are illustrated in FIG. 1). The wheels 5 are coupled to the body 2 or more precisely to the chassis 3 by means of suspensions of known type and not illustrated.

The body 2 or more precisely the bodywork 4 comprises a plurality of walls delimiting a passenger compartment 6 of the motor vehicle 1.

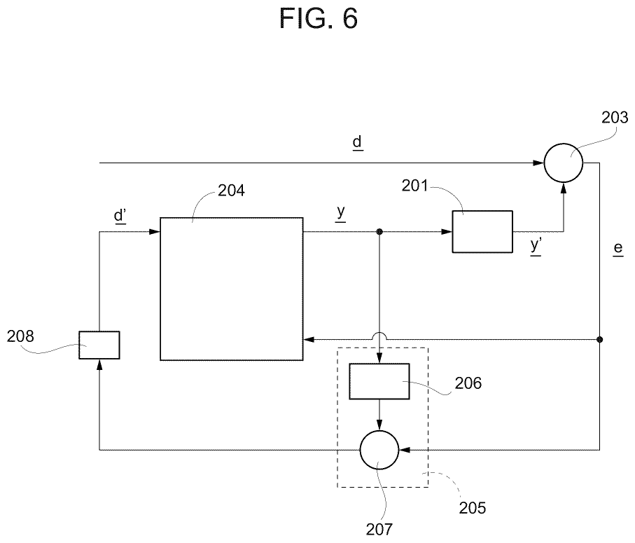

The passenger compartment 6 is illustrated in FIG. 6 and is configured to accommodate one or more passengers, among whom a driver 7.

In other words, the passenger compartment 6 comprises a position (for example comprising a seat for the driver 7 and a steering wheel of the motor vehicle 1) for accommodating the driver 7.

More specifically, the walls comprise the windows of the motor vehicle 1, among which in particular a windshield 9, side windows 10a, 10b, and a rear window 11.

In the illustrated embodiment, the side window 10a is at the front with respect to the side window 10b. In particular, regardless of being more at the front, the side window 10a is coupled to a door 2b of the body 2 in a sliding manner on an inner volume of the door 2b, with respect to the door 2b.

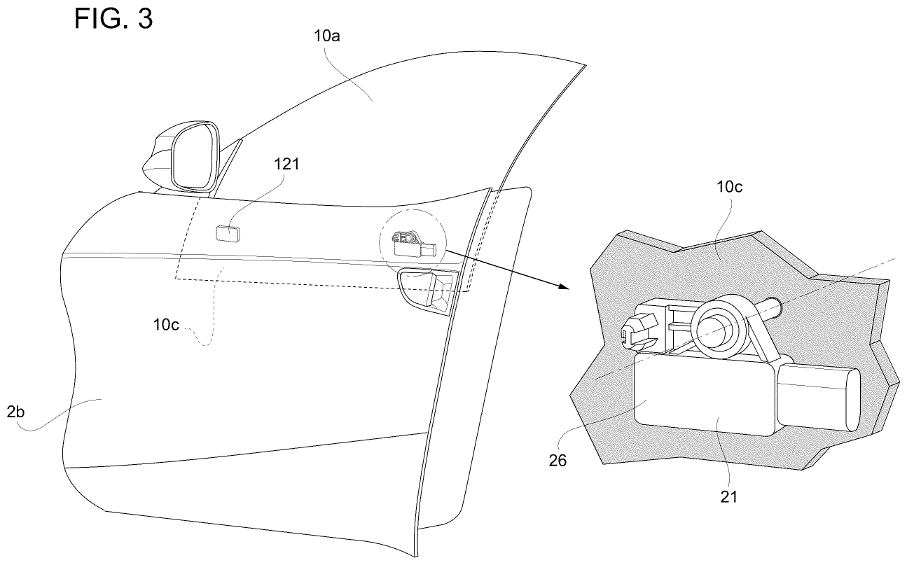

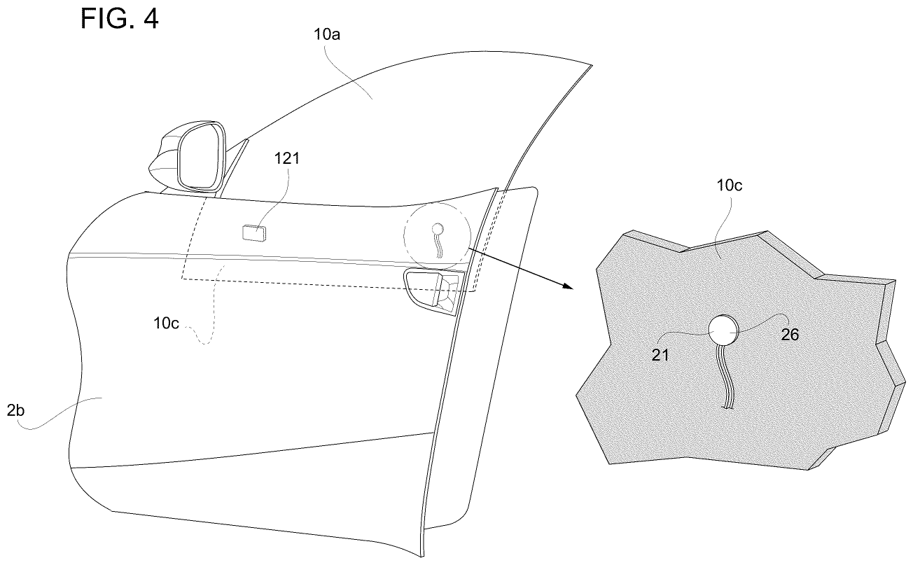

As is visible in FIGS. 3 and 4, referring to distinct variations of the motor vehicle 1, the side window 10a has a hidden portion 10c, which is arranged (in particular always) in the inner volume of the door 2b, for example regardless of the position of the side window 10a with respect to the door 2b.

Furthermore, independently, the side window 10b is fixed with respect to the body 2.

The inner volume of the door 2b is invisible from the outside of the motor vehicle 1.

Furthermore, in the illustrated embodiment, the wall comprising the rear window 11 comprises more in general a hatchback door 12, in turn comprising the rear window 11 and a contour band 13 perimeterally contouring the rear window 11, namely contouring at least a portion of the perimeter of the rear window 11. In particular, the contour band 13 extends in a loop all around the rear window 11, thereby forming a closed contour. Preferably, but not necessarily, the contour band 13 is non-transparent or (in particular completely) opaque, whereby, in other words, the view through the contour band 13 is substantially inhibited, in particular both from the inside of the passenger compartment 6, and from the outside of the motor vehicle 1. Furthermore, the rear window 11 is preferably transparent or has at least a non-zero degree of transparency, at least from the inside of the passenger compartment 6 or also from the outside of the motor vehicle 1, although not necessarily, because the rear window 11 could be opaque both from the inside of the passenger compartment 6, and from the outside of the motor vehicle 1. Windows are known, in fact, that are opaque from the outside and transparent from the inside or windows are known that are even opaque both from the inside and from the outside.

The latter paragraph can be advantageously extended, although not necessarily, to any one among the walls delimiting the passenger compartment 6; any one of these walls could in fact comprise a corresponding window like the rear window 11 (since the rear window 11 is a type of window, and not with the meaning of identical to the rear window 11) and a contour band like the contour band 13. The contour band and the window can in general be part of one single body or be made in one single piece, i.e. be seamlessly fixed to each other.

For example, according to the illustrated embodiment, one of the walls delimiting the passenger compartment 6 comprises the windshield 9 and a related contour band 14.

Likewise, although in an independent manner, another one of the walls delimiting the passenger compartment 6 is or comprises a roof 8 of the motor vehicle 1, which in turn comprises a window 15 and a contour band 16.

The contour bands 13, 14, 16 can share properties similar to one another, i.e. can be (in particular completely) opaque and contour the entire perimeter of the rear window 11, of the windshield 9, and of the roof 8, respectively with respective looped configurations; however, each one of the contour bands 13, 14, 16 could more generally also contour only a portion of the perimeter.

More in general, the roof 8 could comprise or be defined by a sheet, in particular opaque, instead of having the window 15. This could be valid, for example, also for the wall comprising the rear window 11 or the wall comprising one of the side windows 10a, 10b.

In general, at least some of the walls delimiting the passenger compartment 6 have respective inner surfaces 17, which directly face the passenger compartment 6 or, alternatively, are covered with a motor vehicle interior trim layer, for example made of leather, fabric, or plastic material. For example, this aspect, namely having the inner surfaces 17, is valid specifically individually for each one of the walls comprising the windshield 9, the windows 10a, 10b, the rear window 11, as well as for the roof 8. More in particular, this aspect, namely having the inner surfaces 17, could be valid also individually for each one of the walls mentioned in this paragraph in the absence of windows, i.e. respectively in the absence of the windshield 9, the windows 10a, 10b, the rear window 11, or more precisely when completely opaque, for example as defined by respective sheets. Therefore, this could be valid more specifically also for the roof 8 in the case where it is defined by a sheet.

The walls with the inner surfaces 17 could have, each one in an independent manner, corresponding outer surfaces 18 directly exposed on the outside of the motor vehicle 1 (possibly considering a finishing paint as part of the outer surfaces 18) and/or, more in particular, could be or be defined, each one in an independent manner, by single panels with respective thicknesses extending respectively from the inner surfaces 17 to corresponding end surfaces opposite the inner surfaces 17 in the direction of the thickness. The end surfaces could for example coincide with the outer surfaces 18 (with the possible finishing paint included), each one in an independent manner. Having the outer surfaces 18 and/or the fact of being defined by single panels, possibly with the end surfaces coinciding with the outer surfaces 18, could be valid also individually for each one of the walls mentioned in this paragraph in the absence of windows, i.e. respectively in the absence of the windshield 9, the windows 10a, 10b, the rear window 11, or more precisely when completely opaque, for example as defined by respective sheets. Therefore, this could be valid more specifically also for the roof 8 in the case where it is defined by a sheet.

The motor vehicle 1 further comprises an active road noise cancelling apparatus, which is configured to reduce or cancel at least part of the noise perceptible from the inside of the passenger compartment 6 and caused at least in part by the rolling of the wheels 5 on the roadbed during the use of the motor vehicle 1.

The apparatus comprises a plurality of actuators 120, 121, 122, 123, 124 controllable through a control input signal y.

The control input signal y can for example be of vector or matrix type, so as to include a plurality of components respectively pertinent for the independent control of the related actuators 120, 121, 122, 123, 124, or can anyway be considered as a set of single signals respectively pertinent for the independent control of the related actuators 120, 121, 122, 123, 124.

The actuators 120, 121, 122, 123, 124 are not all necessary, whereby their number could vary, so that also only one of the actuators 120, 121, 122, 123, 124 could be present. In the latter case, the control input signal y could be one single signal or, better, have one single component.

The actuators 120, 121, 122, 123, 124 are respectively coupled or applied to corresponding walls among the ones delimiting the passenger compartment 6 and more in particular having the inner surfaces 17.

The actuators 120, 121, 122, 123, 124 are controlled through the control input signal y for transmitting vibrations corresponding to the control input signal y to the corresponding walls, namely for driving into vibration the corresponding walls in a manner corresponding to the control input signal y.

In other words, the actuators 120, 121, 122, 123, 124 transmit the vibrations to the corresponding walls, in particular directly, because respectively applied to the walls.

Since the walls communicate with the passenger compartment 6, the vibrations are indirectly transmitted by the walls to the passenger compartment 6, where a sound y′ is generated by effect of the vibrations of the walls, namely it is produced by means of the actuators 120, 121, 122, 123, 124.

In particular, the actuators 120, 121, 122, 123, 124 are or comprise actuators of electrodynamic or piezoelectric type.

More precisely, the actuators of electrodynamic type are actuated magnetically, i.e. operate by means of the magnetic induction principle. In practice, the actuators of electrodynamic type include windings immersed in a magnetic field configured so that they produce forces on the walls where the actuators of electrodynamic type are applied when passed through by electric current. The forces are proportional to the intensity of the flow of the magnetic field through the windings and to the intensity of the electric current.

The actuators of electrodynamic or piezoelectric type are components structurally known per se and available on the market for various functions. In particular, the actuators of electrodynamic or piezoelectric type are also known as (electrodynamic/piezoelectric) shakers.

The actuators 120, 121, 122, 123, 124 are arranged at the corresponding walls driven into vibration. In practice, the actuators 120, 121, 122, 123, 124 are attached to the respective walls.

In the illustrated embodiment, the actuators 120, 121, 122, 123, 124, are coupled or applied to and in particular arranged at the windshield 9, the side windows 10a, 10b, the rear window 11, and the roof 8.

In particular, the actuators 120, 123, 124 are arranged and/or applied (or attached) to or at the respective contour bands 14, 13, 16, more in particular on the inner side, i.e. towards the passenger compartment 6.

Alternatively or additionally, each one of the transducers 120, 123, 124 can be arranged and/or applied at the related window (respectively the windshield 9, the rear window 11, and the window 15).

For example, the actuator 122 is arranged and/or applied at the window 10b.

The actuator 121 is preferably arranged and/or applied at the hidden portion 10c. The same could be valid for the actuator 122, which could be arranged at a similar hidden portion (not illustrated) of the window 10b.

Each one of the actuators 120, 121, 122, 123, 124 can be coupled or applied to the corresponding wall by means of one or more fastening devices (for example by direct joint or fastening on the wall or on a base adapted for the direct joint or fastening and directly fixed to the wall) or more preferably by means of glueing, in particular direct, or integration onto the wall (as is illustrated for example in FIGS. 3, 4).

Furthermore, advantageously but not necessarily, the apparatus comprises a plurality of transducers 20, 21, 22, 23, 24, each one of which is configured to detect a quantity indicative of an acceleration or a deformation and to generate a related reference signal x. It will always be possible to aggregate the reference signals x in one single reference signal x, for example in vector or matrix format, namely by means of a specially provided pre-established aggregation function. Likewise, without any loss of generality, the apparatus could also comprise only one or more transducers 20, 21, 22, 23, 24; therefore, the single reference signal x could also be the one generated by the single one of the transducers 20, 21, 22, 23, 24 included in the apparatus. In the following, the description will only refer to the single reference signal x, for the sake of descriptive simplicity, but anyway in a non-limiting manner. A person skilled in the art can easily extend the arguments related to the single reference signal x, for example by simply disaggregating, in particular by means of an inverse of the aggregation function, the single reference signal x in the plurality of reference signals x possibly generated.

More specifically, each one of the transducers 20, 21, 22, 23, 24 can comprise an accelerometer 26 and/or a strain gauge 27.

The detected quantity could actually coincide with an acceleration or a deformation, but not necessarily. In general, in the following, an indicative quantity can coincide with the quantity, although not necessarily. More specifically, the expression “indicative of” can be interpreted as “at least derivable in a direct and univocal manner from”, for example by means of one or more pre-established gains or gains variable in a pre-established manner as a function of other detected quantities.

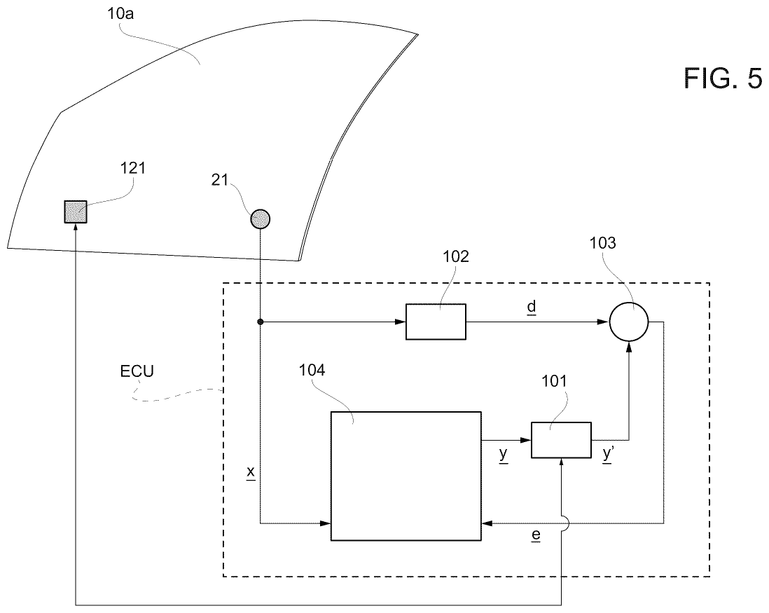

Referring now to FIG. 5, the actuators 120, 121, 122, 123, 124 can be globally represented as a function 101 which associates the control input signal y with the sound y′.

To such regard, it is hereby reminded that the control input signal y is treated as one single signal but it could comprise, in an aggregated form, a plurality of signals configured to control the respective actuators 120, 121, 122, 123, 124, in a manner conceptually similar to what already specified with regard to the reference signal x.

Furthermore, the motor vehicle 1 or the apparatus comprises at least one error sensor 32 configured to detect a quantity indicative of a residual sound or error produced by a superposition of the sound y′ with an interior noise d inside the passenger compartment 6 and to generate a related error signal e.

In other words, the error sensor 32 is configured to detect the residual sound or error. Clearly, the residual sound is inside the passenger compartment 6. Therefore, the error sensor 32 is spaced apart towards the inside of the passenger compartment 6 from the side windows 10a, 10b or from the transducers 20, 21, 22, 23, 24.

As is illustrated in the example in FIG. 7, the error sensor 32 is arranged inside the passenger compartment 6, more in particular at the position for the driver 7, preferably in the upper zone of the position, namely in the zone destined to accommodate the head of the driver 7 or at a height corresponding to the head of the driver 7, i.e. at a height of a headrest of the seat of the position. Alternatively or additionally, the error sensor 32 is arranged inside the passenger compartment 6 at the roof 8.

In particular, the error sensor 32 comprises a detector of a sound wave pressure, which herein defines the quantity indicative of the residual sound or error. For example, the detector can be a microphone.

Therefore, the error sensor 32 is in particular configured to detect the sound wave pressure indicative of the residual sound or error.

Furthermore, the motor vehicle 1 or the apparatus comprises a control unit ECU configured to execute an active noise cancellation algorithm based on the error signal e, as well as preferably the reference signal x.

The control unit ECU is coupled to the error sensor 32 for receiving the error signal e, from which the control unit ECU could extract the piece of information about the error.

The control unit ECU is further preferably coupled to each one of the transducers 20, 21, 22, 23, 24 for receiving the reference signal x.

The control unit ECU determines through the algorithm the control input signal y, which is adapted to cancel, reduce or minimize the residual sound or the error.

According to the embodiment in FIG. 5, the interior noise d corresponds to or is associated with the reference signal x; in other words, the interior noise d is the one caused by the accelerations and/or deformations indicated by the quantities detected by the transducers 20, 21, 22, 23, 24, from which the reference signal x related to the detected quantities is issued.

Actually, the accelerations and/or deformations propagate through the body 2 causing vibrations inside the passenger compartment 6; the vibrations contribute to the formation of the interior noise d inside the passenger compartment 6.

Therefore, it is clear that the interior noise d or the error given by the superposition of the interior noise d and the sound y′ is defined by sound waves in the passenger compartment 6.

More precisely, the reference signal x is associated with the interior noise d, which could be considered as a disturbance sound d, according to an unknown function 102. The sound y′, which is suitable or adapted for cancelling the interior noise d, since it corresponds to the control input signal y by means of the function 101, superposes the disturbance sound d (sum node 103 in FIG. 5), thereby forming the residual sound, which can thus be interpreted as the error to be further reduced or cancelled.

The residual sound is thus the effect of the active noise cancellation algorithm on the interior noise d.

It is thus clear that the interior noise d is different from the accelerations and/or deformations indicated by the quantities detected by the transducers 20, 21, 22, 23, 24, and even more in particular by the abovementioned vibrations in the passenger compartment 6 caused by such accelerations and/or deformations. In fact, as already mentioned, the vibrations contribute to the formation of the interior noise d but they do not necessarily define it. The control unit ECU is configured to control the actuators 120, 121, 122, 123, 124 by means of the control input signal y, so that the actuators 120, 121, 122, 123, 124 cause the sound y′ in the passenger compartment 6.

The active noise cancellation algorithm can also be considered as a transfer function or a similar linear or non-linear function in the time or frequency domain (function 104 in FIG. 5). The algorithm could thus be known per se, for example.

In the specific example in FIG. 5, the active noise cancellation algorithm comprises an adaptive filter configured to output the control input signal y as a function of the reference signal x and of the error or of the error signal e.

More specifically, the adaptive filter is a parametric function associating the reference signal x with the control input signal y and having variable parameters determined by solving an optimization problem of a cost function or optimization function.

In particular, the optimization is or comprises a minimization of the cost function, which is specifically an expected value of a squared modulus of the error or of the error signal e.

Therefore, the adaptive filter is configured as a least mean squares filter.

Preferably, at least one, some among or more preferably all the transducers 20, 21, 22, 23, 24 are respectively coupled or applied to the corresponding walls on which the actuators 120, 121, 122, 123, 124 are applied.

More specifically, the transducers 20, 21, 22, 23, 24 are arranged at the corresponding walls so as to detect the related quantities, which are respectively indicative of the accelerations of the corresponding walls or the deformations of the corresponding walls.

Therefore, implicitly, the accelerations and/or deformations of the walls are associated with the interior noise d or with the error according to an unknown function (just as the reference signal x is associated with the interior noise d according to the function 102). Therefore, the accelerations and/or deformations of the walls are not indicative of the interior noise d and, consequently, in particular of the error.

In other words, the transducers 20, 21, 22, 23, 24 are attached to the corresponding walls.

The accelerations can be with respect to the chassis 3 or more in general with respect to a reference system fixed to the motor vehicle 1, possibly net of the gravity acceleration, such that the related quantities indicative of the accelerations do not substantially take into account the acceleration with which the motor vehicle 1 advances in use or more in general accelerations not having effect on the interior noise d inside the passenger compartment 6.

Conveniently, each one of the corresponding walls is configured such that a coherence between the reference signal x and the interior noise, i.e. the disturbance sound d, is at least greater than 0.7 and more preferably equal to or greater than 0.8.

The coherence could, for example, be defined by a function with real values, which could in turn be defined, for example, as the ratio between the squared modulus of the cross-spectral density between the reference signal x and the disturbance sound d and a product between the respective spectral densities of the reference signal x and of the disturbance sound d.

The coherence is correlated to the unknown function 102 and can be for example estimated and thus determined by means of suitable experimental tests on the motor vehicle 1. The unknown function 102 can also possibly be estimated in an experimental manner by using a suitable model.

The coherence can depend for example on the number and on the material of possible layers interposed between the wall and the passenger compartment 6. The smaller the number of interposed layers, the greater the coherence.

Therefore, in the case where the wall has the inner surface 17, the coherence will be maximized, especially with the absence of the possible covering with the motor vehicle interior trim layer.

In particular, the maximum coherence is expected when the transducers 20, 21, 22, 23, 24 are arranged at the windows.

In the illustrated embodiment, the transducers 20, 21, 22, 23, 24, are coupled and arranged at the windshield 9, the side windows 10a, 10b, the rear window 11, and the roof 8.

In particular, the transducers 20, 23, 24 are arranged or attached to or at the respective contour bands 14, 13, 16, more in particular on the inner side, i.e. towards the passenger compartment 6.

Alternatively or additionally, each one of the transducers 20, 23, 24 can have at least one element arranged at the related window (respectively the windshield 9, the rear window 11, and the window 15). Preferably, the latter element is transparent. The transparent element could be an accelerometer, a strain gauge, or any electric member, such as for example a cable.

The element could in particular be a sensible element configured to detect the related quantity.

For example, the transducer 22 comprises the transparent element or is entirely transparent and is arranged at the window 10b.

The transducer 21 is preferably arranged at the hidden portion 10c. The same could apply to the transducer 22, which could be arranged at the similar hidden portion (not illustrated) of the window 10b.

In particular, according to the variation in FIG. 3, the transducer 21 comprises an accelerometer fixed to the window 10a (in particular at the hidden portion 10c) by means of a fastening device, in particular a bolt.

According to a variation in FIG. 4, the transducer 21 comprises a strain gauge applied to the window 10a (in particular at the hidden portion 10c), for example by means of glueing or by means of integration in the window 10a.

More in general, each one of the transducers 20, 21, 22, 23, 24 can be coupled to the corresponding wall by means of a fastening device (for example, when it comprises an accelerometer similar to the variation in FIG. 3) or by means of glueing to or integration in the wall (for example, when it comprises a strain gauge similar to the variation in FIG. 4).

The embodiment in FIG. 6, although conceptually distinct, has some similarities with the embodiment in FIG. 5, therefore it will be described specifying in detail only the differences of the latter. The similar signals will be in particular indicated by the same symbol used in FIG. 5, whereas the similar functions will be indicated by a reference numeral having one hundred more than those in FIG. 5.

In particular, the reference signal x is replaced by an estimate d′ of the interior noise d.

Herein, i.e. in the embodiment in FIG. 6, the control unit ECU comprises a model (which can be represented for example as a function, in particular a transfer function 205), in particular a mathematical model, for determining the estimate d′ of the interior noise d as a function of the control input signal y and of the error signal e.

The model is preferably stored by the control unit ECU and determined experimentally, in particular identified, for example by means of one among the known model identification methods from experimental data, during calibration tests of the motor vehicle 1. Alternatively or additionally, the model can be updated or determined in real time during the use of the motor vehicle 1 through known learning algorithms, for example based on artificial intelligence, without any loss of generality. The model could also be updatable at the end of a specific utilization session of the motor vehicle 1, in which sufficient data are collected for again identifying the model.

More specifically, the model comprises in turn a primary model (which can be represented for example as a function, in particular a transfer function 206), for example a mathematical primary model, for determining an estimate of the sound y′ as a function of the control input signal y. In practice, the primary model simulates or approximates or estimates the operation of the actuators 120, 121, 122, 123, 124 on the motor vehicle 1 as if the actuators 120, 121, 122, 123, 124 were controlled by means of the control input signal y, thereby determining the estimate of the sound y′. With regard to the determination of the primary model, the same considerations just made for the model in general are valid.

Therefore, the model comprises a determination function 207 (represented as a sum node in FIG. 6) for determining the estimate d′ of the interior noise d from the estimate of the sound y′ and from the error signal e, in particular considering that the latter was given by the superposition of the interior noise d with the actual sound y′. In fact, the determination function 207 deducts (i.e. in practice subtracts) the estimate of the sound y′ from the error signal e, thereby obtaining the estimate d′ of the interior noise d.

In particular, the control unit ECU is configured to estimate a sort of reference signal, similar to the embodiment in FIG. 5, which is defined by the estimate d′ by means of the model. Therefore, similar to the embodiment in FIG. 5, the control unit ECU executes the active noise cancellation algorithm with the adaptive filter to output the control input signal y as a function of the estimated reference signal, i.e. in this case of the estimate d′, and of the error signal e.

Still more specifically, the control unit ECU obtains the estimate d′ for or at a current instant (of time), in particular as a function of the control input signal y and of the error signal e at the current instant. However, the adaptive filter provides the control input signal y for or at a following instant (of time), always as a function of the estimate d′ and of the error signal e for the current instant. Furthermore, the adaptive filter corrects the error with a delay of an instant. The latter concept is represented by the function 208 in FIG. 6, which represents the so-called unitary delay function in the control field.

In the light of the above, the embodiments in FIG. 5 and FIG. 6 refer to feedforward and feedback active noise cancelling schemes, respectively.

Clearly, in the embodiment in FIG. 6, the transducers 20, 21, 22, 23, 24 are totally superfluous, whereby they can be absent.

Based on the embodiments in FIGS. 5 and 6, it is inferable that more generally, the transducers 20, 21, 22, 23, 24 are not essential and that the active noise cancellation algorithm may not be based on the reference signal x, but also only on the error signal e. In other words, the active noise cancellation algorithm could comprise an adaptive filter configured to output the control input signal y as a function of the error signal e, where the adaptive filter could be a parametric function associating the error signal e with the control input signal y and having variable parameters determined by the active noise cancelling parameter solving an optimization problem of an optimization function associated with the error signal e, where preferably the optimization comprises a minimization of the optimization function or more simply of the error signal e or of the residual sound, namely of an expected value of its squared modulus.

Based on the foregoing, the advantages of the motor vehicle 1 according to the invention are evident.

The actuators 120, 121, 122, 123, 124 act, in particular directly, on the walls, the vibration of which, according to studies by the Applicant, has a very strong correlation or coherence with the interior noise d. In this manner, the apparatus intervenes directly on that which is substantially the real main source of the noise in the passenger compartment 6, thereby achieving a high cancellation efficacy of the interior noise d, without any need to increase the number of transducers. The transducers 20, 21, 22, 23, 24 could even be absent.

On the other hand, advantageously, the arrangement of the transducers 20, 21, 22, 23, 24, which guarantees a high coherence between the reference signal x and the interior noise inside the passenger compartment 6, involves an additional bonus effect in terms of efficacy with respect to the prior art, for example with respect to solutions with the transducers arranged in the proximity of the wheels 5 or of the four corners of the motor vehicle 1.

Finally, it is clear that modifications and variations can be made to the motor vehicle 1 according to the invention which anyway do not depart from the scope of protection defined by the claims.

In particular, all the mentioned signals can be mono-dimensional or pluri-dimensional, without any loss of generality.

Furthermore, the number of the described components could vary, as well as the geometrical shape and the dimensions of the described and illustrated components.

The values indicated within a described interval are to be understood as all described individually, also if not explicitly mentioned in a precise manner.

The interior noise could also contain components which are not to be attributed only and exclusively to the rolling of the wheels 5 on the road; but rather, the interior noise could also include components linked to vibrations peculiar of the walls delimiting the passenger compartment 6 during the utilization of the motor vehicle 1.

Furthermore, the correspondences of the transducers 20, 21, 22, 23, 24 and/or of the actuators 120, 121, 122, 123, 124 with the respective walls are not to be understood as essential, but can be varied, thereby each one of the transducers 20, 21, 22, 23, 24 and/or actuators 120, 121, 122, 123, 124 can be coupled to a different wall with respect to the corresponding one specifically described and illustrated in the drawings.

Finally, the characteristics of each one of the transducers 20, 21, 22, 23, 24 or of the actuators 120, 121, 122, 123, 124 can be integrally exchanged with those of another one of the transducers 20, 21, 22, 23, 24 or of the actuators 120, 121, 122, 123, 124, without any loss of generality.

1. A motor vehicle, comprising:
a body comprising a chassis and a plurality of walls, the walls delimiting a passenger compartment to accommodate one or more passengers;
at least one actuator applied to a corresponding wall between said walls and controllable through a control input signal to transmit a vibration corresponding to the control input signal to the corresponding wall, thereby producing a corresponding sound inside the passenger compartment;
an error sensor configured to detect a quantity indicative of a residual sound produced by a superposition of said sound with an interior noise inside the passenger compartment and to generate a related error signal; and
a control unit coupled to the error sensor to receive the error signal, configured to execute an active noise cancellation algorithm based on the error signal, so as to determine the control input signal adapted to minimize or reduce the residual sound, and further configured to control the actuator with the determined control input signal.

2. The motor vehicle according to claim 1, wherein the actuator is arranged at the corresponding wall and is configured to transmit the vibration directly to the corresponding wall.

3. The motor vehicle according to claim 1, wherein the corresponding wall has a respective inner surface directly facing the passenger compartment or covered with a motor vehicle interior trim layer.

4. The motor vehicle according to claim 3, wherein the corresponding wall has an outer surface directly exposed on the outside of the motor vehicle or covered with a further trim layer directly exposed on the outside of the motor vehicle.

5. The motor vehicle according to claim 4, wherein the further trin layer comprises a layer of paint.

6. The motor vehicle according to claim 4, wherein the corresponding wall is a single panel with a thickness extending from the inner surface to the outer surface.

7. The motor vehicle according to claim 1, wherein the corresponding wall comprises a window of the motor vehicle.

8. The motor vehicle according to claim 7, wherein the corresponding wall comprises a non-transparent contour band perimeterally contouring the window.

9. The motor vehicle according to claim 8, wherein the actuator is applied at the contour band.

10. The motor vehicle according to claim 7, wherein the window comprises a hidden portion arranged within an inner volume of the body, the inner volume being invisible from the outside of the motor vehicle, and wherein the actuator is applied at the hidden portion.

11. The motor vehicle according to claim 1, further comprising at least one transducer configured to detect a quantity indicative of an acceleration or deformation of a component of the motor vehicle and to generate a related reference signal, the control unit being coupled to the transducer to receive the reference signal, and wherein the active noise cancellation algorithm comprises an adaptive filter configured to output the control input signal as a function of the reference signal and of the error signal.

12. The motor vehicle according to claim 11, wherein the transducer is coupled to the corresponding wall so as to detect said quantity, whereby the quantity is indicative of the acceleration of the corresponding wall or the deformation of the corresponding wall.

13. The motor vehicle according to claim 1, wherein the control unit comprises a model for determining an estimate of said interior noise as a function of the control input signal and of the error signal at a current instant, and is configured to estimate a reference signal for the current instant defined by said estimate by means of said model, wherein the active noise cancellation algorithm comprises an adaptive filter configured to output the control input signal at an instant following the current instant as a function of the estimated reference signal and of the error signal.

14. The motor vehicle according to claim 13, wherein the adaptive filter is a parametric function associating the reference signal with the control input signal and having variable parameters determined by the active noise cancellation algorithm by solving an optimization problem of an optimization function associated with the error signal.

15. The motor vehicle according to claim 14, wherein the optimization comprises a minimization of the optimization function defining a cost function, the cost function being an expected value of a squared modulus of the error signal.

16. A motor vehicle, comprising:
a body, comprising:
a chassis;
a passenger compartment to accommodate one or more passengers; and
a wall;
an actuator applied to the wall, wherein the actuator is controllable through a control input signal to transmit a vibration corresponding to the control input signal to the wall thereby producing a corresponding sound inside the passenger compartment;
an error sensor configured to detect a quantity indicative of a residual sound produced by a superposition of said sound with an interior noise inside the passenger compartment and to generate a related error signal; and
a control unit configured to:
receive the error signal;
execute an active noise cancellation algorithm based on the error signal, so as to determine the control input signal adapted to reduce the residual sound; and
control the actuator with the determined control input signal.
